(19) United States
(12) Patent Application Publication
(10) Pub. No.: US 2017/0308655 A1
(43) Pub. Date: Oct. 26, 2017

(54) System and Method for Evaluating Treatment Options

(71) Applicant: National Comprehensive Cancer Network, Fort Washington, PA (US)

(72) Inventors: Robert W. CARLSON, Doylestown, PA (US); Gary J. WEYHMULLER, North Wales, PA (US); Lyn C. FITZGERALD, Penn Valley, PA (US); Joan S. MCCLURE, Ambler, PA (US)

(73) Assignee: National Comprehensive Cancer Network, Fort Washington, PA (US)

(21) Appl. No.: 15/517,425

(22) PCT Filed: Oct. 6, 2015
(86) PCT No.: PCT/US2015/054158

§ 371 Date: Apr. 6, 2017

Related U.S. Application Data
(60) Provisional application No. 62/060,279, filed on Oct. 6, 2014.

(51) Int. Cl. G06F 19/00

(52) U.S. Cl. CPC G06F 19/345; G06F 19/324; G06F 19/3431

(57) ABSTRACT

A computer-implemented method of ranking and presenting evaluation criteria for medical treatment options, including: populating, by a computer processor, a database with a score set for each of a plurality of treatment options, the score set including a plurality of outcome characteristic scores; transmitting, by the computer processor, first display instructions that when implemented results in a plurality of graphical score displays and a plurality of treatment option displays, wherein each graphical score display having a plurality of indicia having an indication that reflects: i) one of the score sets and ii) the plurality of outcome characteristic scores included in the score set, the instructions further causing each graphical score display to display proximate one of the treatment option displays such that a user associates the graphical score display with the treatment option display.

### CROSS-REFERENCE TO RELATED APPLICATIONS

This application claims the benefit of U.S. Provisional Application No. 62/060,279, entitled “System and Method for Evaluating Treatment Options,” filed Oct. 6, 2014, and incorporated by reference herein in its entirety.

### FIELD OF THE INVENTION

The present invention generally relates to improving medical decision-making and ascertaining value, and more specifically, to a system and method for improving medical decision-making by evaluating treatment options.

### BACKGROUND

The methods and manner of treatment of cancer and other medical conditions are continually changing. This provides challenges to health care providers, patients, payers, and other stakeholders in the ability make optimal decisions in patient care. One tool to assist these stakeholders in optimal decision making is the use of clinical practice guidelines. Clinical practice guidelines may be considered “systematically developed statements to assist practitioner and patient decisions about appropriate health care for specific clinical circumstances” as defined by Clinical Practice Guidelines: Directions for a New Program (Marilyn J. Field & Kathleen N. Lohr eds., 1990), herein incorporated by reference in its entirety. For example, the range of appropriate first line therapies for hormone receptor positive metastatic breast cancer is different from those for hormone receptor negative metastatic breast cancer.

There are a number of methods of developing clinical practice guidelines. For example, groups of individuals with expertise in the medical condition and/or the methodology of clinical practice guideline development may assess the relevant literature, clinical trials results, and clinical experience and make evidence-based recommendations, or in circumstances where the evidence is lacking or inconclusive, consensus-based recommendations. A number of characteristics have been identified that may be used to assess the quality of clinical practice guidelines, most of which relate to how the guidelines are developed and described. In the field of medicine, it is generally agreed that experts representing the various disciplines responsible for providing care should be involved in the guideline development, high quality scientific evidence should be used and evaluated whenever available, conflicts of interest should be rigorously managed, the process for guideline development should be transparent, and the rationale for the recommendations should be explicitly provided. One such group of clinical practice guidelines are embodied as the NCCN Clinical Practice Guidelines, and represent clinical practice guidelines covering over 95% of all cancer patients in the United States.

First published in 1996, the NCCN Guidelines outline the clinical decision making process used by physicians in the management of cancer. Multidisciplinary disease sub-specialist clinician researchers supported by expert staff produce these guidelines. As sub-specialists, panel members have the capacity to track and integrate disease-specific data that has developed over the past several decades. In a rapidly evolving field like oncology, thousands of new publications are released each year adding to the existing body of knowledge and resulting in incremental improvements in outcomes. Experts are able to integrate new findings with existing information to determine what the evolving standard of care should be for a given disease site.

However, one challenge in developing high quality guidelines is making the rationale used by developers to make decisions about appropriate treatment options clear to users of the guidelines.

Another challenge is providing the users with sufficient information to select the most appropriate option for a given clinical situation and patient from among a number of potentially appropriate options. These challenges exist because, when clinicians evaluate treatment options, and especially treatment options used in oncology care, it may be overwhelming to access all of the relevant studies to determine whether a treatment option is appropriate.

In addition, even if a clinician has access to all of the studies, simply providing references to the studies for access by users may not be effective. For example, in a group of more than 200 different diseases with wide ranging incidence rates, there is significant variability in the amount and quality of evidence available across diseases. This makes it difficult for clinicians to properly evaluate different treatment options. For this reason, access to scores developed by domain experts who can assess different outcome characteristic data such as efficacy and safety (or absence of toxicity) data as well as the quality of the evidence supporting a treatment option in a given disease may be valuable. In a disease like breast cancer where hundreds of high quality randomized trials supporting effective treatment options have informed decision making for decades, greater certainty regarding the reliability of the efficacy and safety data would be expected than in a low incidence disease with few randomized trials like uterine sarcomas. By making outcome characteristic data for a treatment option, such as quality and consistency of evidence, easily accessible and displayed in a user-friendly format, clinicians can look at treatment option recommendations in the context of the level of evidence available for that particular disease, essentially normalizing the data across disease sites.

In addition, in some embodiments, relative financial impact of a particular treatment can be reflected in terms of cost or affordability. In one embodiment, the selection of which term is used is determined based on the scale that might be selected to represent that value. By providing affordability data in addition to other outcome characteristic data, clinicians can provide more informed recommendations to patients that also consider affordability along with the other characteristics.

Clinical decision making has several components that may need to be considered as a whole to make a decision regarding best value for an individual patient's circumstances. First the efficacy of treatment might be considered; second the safety of the treatment might be weighed in light of the efficacy. In addition the reliability of the data supporting the efficacy and safety may be assessed. Finally, the affordability of the intervention may be considered. Providing a reliable, efficient way to compare these attributes across multiple treatment choices has proven a difficult challenge for clinicians.

### BRIEF SUMMARY OF THE INVENTION

In one embodiment, there is a computer-implemented method of ranking and presenting evaluation criteria for medical treatment options, including populating, by a computer processor, a database with a score set for each of a plurality of treatment options, the score set including a plurality of outcome characteristic scores; transmitting, by the computer processor, first display instructions that when implemented results in a plurality of graphical score displays and a plurality of treatment option displays, wherein each graphical score display having a plurality of indicia having an indication that reflects: i) one of the score sets and ii) the plurality of outcome characteristic scores included in the score set, the instructions further causing each graphical score display to display proximate one of the treatment option displays such that a user associates the graphical score display with the treatment option display.

In a further embodiment, each of the plurality of outcome characteristic scores represents an outcome characteristic of at least one of: efficacy, benefit, toxicity, safety, harm, quality of evidence, consistency of evidence, cost and affordability.

In a further embodiment, each graphical score display comprises an array including a plurality of cells and wherein the plurality of cells are arranged in rows and columns in the array, each column representing one of the outcome characteristics.

In a further embodiment, each of the outcome characteristic scores is determined based on the same numerical scale that includes five value levels.

In a further embodiment, one of the plurality of outcome characteristics includes efficacy and wherein the outcome characteristic score for efficacy is ranked according to the group consisting of highly effective, very effective, moderately effective, minimally effective and palliative only.

In a further embodiment, at least two graphical score displays are displayed simultaneously such a user can compare the at least two graphical score displays.

In a further embodiment, the database includes at least one of: an outcome characteristic field, a treatment option field, a clinical practice guideline field and an outcome characteristic score field.

In a further embodiment, one of the plurality of outcome characteristics includes safety and wherein the outcome characteristic score for safety is ranked according to the group consisting of usually no meaningful toxicity, occasionally toxic, mildly toxic, moderately toxic, and highly toxic.

In a further embodiment, one of the plurality of outcome characteristics includes quality of evidence and wherein the outcome characteristic score for quality of evidence is ranked according to the group consisting of high quality, good quality, average quality, low quality, poor quality or non-meaningful evidence.

In a further embodiment, one of the plurality of outcome characteristics includes consistency of evidence and wherein the outcome characteristic score for consistency of evidence is ranked according to the group consisting of highly consistent, mainly consistent, may be consistent, inconsistent, anecdotal evidence only.

In a further embodiment, one of the plurality of outcome characteristics includes affordability and wherein the outcome characteristic score for affordability is ranked according to the group consisting of very inexpensive, inexpensive, moderately expensive, expensive, and very expensive.

In a further embodiment, each of the outcome characteristic scores is determined based on the same numerical scale.

In a further embodiment, the method further comprising: receiving, by the computer processor, a request for an outcome characteristic display developer web page.

In a further embodiment, the method further comprising: transmitting, by the computer processor, the outcome characteristic display developer web page to a client device.

In a further embodiment, the method further comprising: receiving, by the computer processor, the score set associated with each of the plurality of treatment options.

In a further embodiment, the method further comprising: receiving, by the computer processor, first graphical coordinate data associated with each of the plurality of treatment option displays, in response to user input via user-selectable and user-movable treatment option displays on the outcome characteristic display developer web page.

In a further embodiment, the method further comprising: populating, by the computer processor, the database with the first graphical coordinate data associated with each of the plurality of treatment option displays.

In a further embodiment, the method further comprising: receiving, by the computer processor, second graphical coordinate data associated with each of the plurality of graphical score displays, in response to user input via user-selectable and user-movable graphical elements representing the graphical score displays on the outcome characteristic display developer web page.

In a further embodiment, the method further comprising: populating, by the computer processor, the database with the second graphical coordinate data associated with each of the plurality of graphical score displays.

In a further embodiment, the first graphical coordinate data and the second graphical coordinate data are applied to produce the instructions further causing each graphical score display to display proximate one of the treatment option displays such that an end user associates the graphical score display with the treatment option display.

In a further embodiment, at least two graphical score displays simultaneous display on a single screen so that an end user view the screen can simultaneously view the at least two graphical score displays.

In a further embodiment, each graphical score display includes a hyperlink that, when selected, causes the computer processor to transmit a web page that displays reference data used to determine one or more outcome characteristic scores.

In a further embodiment, each graphical score display includes a plurality of hyperlinks, each hyperlink corresponding to a specific outcome characteristic score reflected on the graphical score display and being configured to cause the computer processor to transmit a web page that displays reference data used to determine the specific outcome characteristic score.

In another embodiment, there is a system of ranking and presenting evaluation criteria for medical treatment options, including: one or more memory units each operable to store at least one program; and at least one processor communicatively coupled to the one or more memory units, in which the at least one program, when executed by the at least one processor, causes the at least one processor to perform the steps of: populating, by a computer processor, a database with a score set for each of a plurality of treatment options, the score set including a plurality of outcome characteristic scores; transmitting, by the computer processor, first display instructions that when implemented results in a plurality of graphical score displays and a plurality of treatment option displays, wherein each graphical score display having a plurality of indicia having an indication that reflects: i) one of the score sets and ii) the plurality of outcome characteristic scores included in the score set, the instructions further causing each graphical score display to display proximate one of the treatment option displays such that a user associates the graphical score display with the treatment option display.

In a further embodiment, each of the plurality of outcome characteristic scores represents an outcome characteristic of at least one of: efficacy, benefit, toxicity, safety, harm, quality of evidence, consistency of evidence, and affordability.

In a further embodiment, each graphical score display comprises an array including a plurality of cells and wherein the plurality of cells are arranged in rows and columns in the array, each column representing one of the outcome characteristics.

In a further embodiment, each of the outcome characteristic scores is determined based on the same numerical scale that includes five value levels.

In a further embodiment, one of the plurality of outcome characteristics includes efficacy and wherein the outcome characteristic score for efficacy is ranked according to the group consisting of highly effective, very effective, moderately effective, minimally effective and palliative only.

In a further embodiment, at least two graphical score displays are displayed simultaneously such a user can compare the at least two graphical score displays.

In a further embodiment, the database includes at least one of: an outcome characteristic field, a treatment option field, a clinical practice guideline field and an outcome characteristic score field.

In a further embodiment, one of the plurality of outcome characteristics includes safety and wherein the outcome characteristic score for safety is ranked according to the group consisting of usually no meaningful toxicity, occasionally toxic, mildly toxic, moderately toxic, and highly toxic.

In a further embodiment, one of the plurality of outcome characteristics includes quality of evidence and wherein the outcome characteristic score for quality of evidence is ranked according to the group consisting of high quality, good quality, average quality, low quality, poor quality or non-meaningful evidence.

In a further embodiment, one of the plurality of outcome characteristics includes consistency of evidence and wherein the outcome characteristic score for consistency of evidence is ranked according to the group consisting of highly consistent, mainly consistent, may be consistent, inconsistent, anecdotal evidence only.

In a further embodiment, one of the plurality of outcome characteristics includes affordability and wherein the outcome characteristic score for affordability is ranked according to the group consisting of very inexpensive, inexpensive, moderately expensive, expensive, and very expensive.

In a further embodiment, each of the outcome characteristic scores is determined based on the same numerical scale.

In a further embodiment, the processor further performs the step(s) of: receiving, by the computer processor, a request for an outcome characteristic display developer web page.

In a further embodiment, the processor further performs the step(s) of: transmitting, by the computer processor, the outcome characteristic display developer web page to a client device;

In a further embodiment, the processor further performs the step(s) of: receiving, by the computer processor, the score set associated with each of the plurality of treatment options.

In a further embodiment, the processor further performs the step(s) of: receiving, by the computer processor, first graphical coordinate data associated with each of the plurality of treatment option displays, in response to user input via user-selectable and user-movable treatment option displays on the outcome characteristic display developer web page.

In a further embodiment, the processor further performs the step(s) of: populating, by the computer processor, the database with the first graphical coordinate data associated with each of the plurality of treatment option displays.

In a further embodiment, the processor further performs the step(s) of: receiving, by the computer processor, second graphical coordinate data associated with each of the plurality of graphical score displays, in response to user input via user-selectable and user-movable graphical elements representing the graphical score displays on the outcome characteristic display developer web page.

In a further embodiment, the processor further performs the step(s) of: populating, by the computer processor, the database with the second graphical coordinate data associated with each of the plurality of graphical score displays.

In a further embodiment, the first graphical coordinate data and the second graphical coordinate data are applied to produce the instructions further causing each graphical score display to display proximate one of the treatment option displays such that an end user associates the graphical score display with the treatment option display.

In a further embodiment, at least two graphical score displays simultaneous display on a single screen so that an end user view the screen can simultaneously view the at least two graphical score displays.

In a further embodiment, each graphical score display includes a hyperlink that, when selected, causes the computer processor to transmit a web page that displays reference data used to determine one or more outcome characteristic scores.

In a further embodiment, each graphical score display includes a plurality of hyperlinks, each hyperlink corresponding to a specific outcome characteristic score reflected on the graphical score display and being configured to cause the computer processor to transmit a web page that displays reference data used to determine the specific outcome characteristic score.

In another embodiment, there is a non-transitory computer readable storage medium having stored thereon computer-executable instructions which, when executed by a processor, performs the steps of: populating, by a computer processor, a database with a score set for each of a plurality of treatment options, the score set including a plurality of outcome characteristic scores; transmitting, by the computer processor, first display instructions that when implemented results in a plurality of graphical score displays and a plurality of treatment option displays, wherein each graphical score display having a plurality of indicia having an indication that reflects: i) one of the score sets and ii) the plurality of outcome characteristic scores included in the score set, the instructions further causing each graphical score display to display proximate one of the treatment option displays such that a user associates the graphical score display with the treatment option display.

In a further embodiment, each of the plurality of outcome characteristic scores represents an outcome characteristic of at least one of: efficacy, benefit, toxicity, safety, harm, quality of evidence, consistency of evidence, cost and affordability.

In a further embodiment, each graphical score display comprises an array including a plurality of cells and wherein the plurality of cells are arranged in rows and columns in the array, each column representing one of the outcome characteristics.

In a further embodiment, each of the outcome characteristic scores is determined based on the same numerical scale that includes five value levels.

In a further embodiment, one of the plurality of outcome characteristics includes efficacy and wherein the outcome characteristic score for efficacy is ranked according to the group consisting of highly effective, very effective, moderately effective, minimally effective and palliative only.

In a further embodiment, at least two graphical score displays are displayed simultaneously such a user can compare the at least two graphical score displays.

In a further embodiment, the database includes at least one of: an outcome characteristic field, a treatment option field, a clinical practice guideline field and an outcome characteristic score field.

In a further embodiment, one of the plurality of outcome characteristics includes safety and wherein the outcome characteristic score for safety is ranked according to the group consisting of usually no meaningful toxicity, occasionally toxic, mildly toxic, moderately toxic, and highly toxic.

In a further embodiment, one of the plurality of outcome characteristics includes quality of evidence and wherein the outcome characteristic score for quality of evidence is ranked according to the group consisting of high quality, good quality, average quality, low quality, poor quality or non-meaningful evidence.

In a further embodiment, one of the plurality of outcome characteristics includes consistency of evidence and wherein the outcome characteristic score for consistency of evidence is ranked according to the group consisting of highly consistent, mainly consistent, may be consistent, inconsistent, anecdotal evidence only.

In a further embodiment, one of the plurality of outcome characteristics includes affordability and wherein the outcome characteristic score for affordability is ranked according to the group consisting of very inexpensive, inexpensive, moderately expensive, expensive, and very expensive.

In a further embodiment, each of the outcome characteristic scores is determined based on the same numerical scale.

In a further embodiment, the processor further performs the step(s) of: receiving, by the computer processor, a request for an outcome characteristic display developer web page.

In a further embodiment, the processor further performs the step(s) of: transmitting, by the computer processor, the outcome characteristic display developer web page to a client device;

In a further embodiment, the processor further performs the step(s) of: receiving, by the computer processor, the score set associated with each of the plurality of treatment options.

In a further embodiment, the processor further performs the step(s) of: receiving, by the computer processor, first graphical coordinate data associated with each of the plurality of treatment option displays, in response to user input via user-selectable and user-movable treatment option displays on the outcome characteristic display developer web page.

In a further embodiment, the processor further performs the step(s) of: populating, by the computer processor, the database with the first graphical coordinate data associated with each of the plurality of treatment option displays.

In a further embodiment, the processor further performs the step(s) of: receiving, by the computer processor, second graphical coordinate data associated with each of the plurality of graphical score displays, in response to user input via user-selectable and user-movable graphical elements representing the graphical score displays on the outcome characteristic display developer web page.

In a further embodiment, the processor further performs the step(s) of: populating, by the computer processor, the database with the second graphical coordinate data associated with each of the plurality of graphical score displays.

In a further embodiment, the first graphical coordinate data and the second graphical coordinate data are applied to produce the instructions further causing each graphical score display to display proximate one of the treatment option displays such that an end user associates the graphical score display with the treatment option display.

In a further embodiment, at least two graphical score displays simultaneous display on a single screen so that an end user view the screen can simultaneously view the at least two graphical score displays.

In a further embodiment, each graphical score display includes a hyperlink that, when selected, causes the computer processor to transmit a web page that displays reference data used to determine one or more outcome characteristic scores.

In a further embodiment, each graphical score display includes a plurality of hyperlinks, each hyperlink corresponding to a specific outcome characteristic score reflected on the graphical score display and being configured to cause the computer processor to transmit a web page that displays reference data used to determine the specific outcome characteristic score.

### BRIEF DESCRIPTION OF THE SEVERAL VIEWS OF THE DRAWINGS

The foregoing summary, as well as the following detailed description of embodiments of the system and method, will be better understood when read in conjunction with the appended drawings of an exemplary embodiment. It should be understood, however, that the invention is not limited to the precise arrangements and instrumentalities shown.

In the drawings:

FIG. 1 shows a block diagram that illustrates a system for improving medical decision-making by evaluating treatment options according to at least one embodiment of the present invention;

FIG. 2 is a block diagram showing the main components of a computer suitable for use in the system of FIG. 1 in accordance with at least one embodiment of the invention;

FIG. 3 shows a flow chart that illustrates a method for improving medical decision-making by evaluating treatment options according to at least one embodiment of the invention;

FIG. 4 depicts a screenshot of an exemplary outcome characteristic display developer web page according to at least one embodiment of the invention;

FIG. 5A shows an example of an outcome characteristic graphical score display for a treatment option according to at least one embodiment of the invention;

FIG. 5B shows an alternative example of an outcome characteristic graphical score display for a treatment option according to at least one embodiment of the invention;

FIG. 6 is a screenshot of a first configuration of the outcome characteristic graphical score display proximate a treatment option display according to at least one embodiment of the invention;

FIG. 7 is a screenshot of a second configuration of the outcome characteristic graphical score display proximate a treatment option display according to at least one embodiment of the invention; and

FIG. 8 is a screenshot of a third configuration of the outcome characteristic graphical score display proximate a treatment option display according to at least one embodiment of the invention.

### DETAILED DESCRIPTION OF THE INVENTION

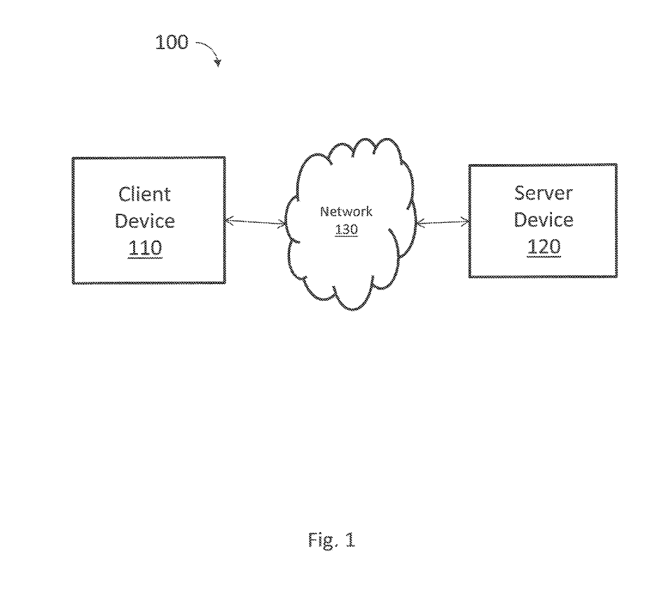

Referring to the drawings in detail, wherein like reference numerals indicate like elements throughout, there is shown in FIGS. 1-8, a system and method for improving medical decision-making by evaluating treatment options, generally designated, in accordance with an exemplary embodiment of the present invention.

FIG. 1 shows a block diagram that illustrates a system 100 for improving medical decision-making by evaluating treatment options according to at least one embodiment of the present invention. In at least one embodiment, the system 100 may include one or more computers or servers, non-transitory memory operable to store one or more computer programs and one or more processors to implement the one or more computer programs. For example, system 100 may include client device 110, server device 120 and network 130.

Client device 110 may be a computing device for receiving inputs from a user, requesting data from server device 120 via network 130 and/or displaying data from server device 120 at the request of a user. Examples of a client device 110 may include a smart phone, tablet or a personal computer, among others.

Server device 120 may be any computing device for receiving requests for data from client device 110 or from a user interfacing directly with server device 120. Examples of data may include web page data, hyper text markup language (HTML), text, video, picture, software, executable, interpretable, byte-code, and binary files.

Network 130 connects client device 110 and server device 120 by carrying signals. The network may be implemented using wire or cable, fiber optics, a phone line, a wireless link, a cellular phone link, a radio frequency link, or any other suitable communication channel. For instance, the network may be implemented using a combination of channels. The network may also be implemented as a connection of one or more computing devices configured as an intranet and/or an internet.

In some embodiments, server device 120 may be a web server that hosts a website. Client device 110 may request data, such as web page data, from server device 120 using a hyper text transfer protocol (HTTP). Client device 110 may transmit HTTP GET requests to retrieve data from server device 120. Client device 110 may transmit HTTP POST requests to store data at server device 120. Server device 120 may receive the data requests and transmit the data to client device 110. The user may instruct client device 110 to request data from server device 120 using HTTP requests. Server device 120 may respond to data requests by sending data to client device 110.

In some embodiments, data may include web page data such as an HTML web page. Data may include an HTML form that may contain user-input elements including user-fillable fields such as text fields, checkboxes, and radio-buttons, as well as user-selectable icons such as submit buttons. In embodiments, server device 120 may respond to asynchronous (i.e. in the background) data requests from client device 110 that do not alter the display and behavior of the data displayed on client device 110.

In some embodiments, server device 120 may receive requests from a user via a user interface of the server device 120. The user may request data from server device 120 for display on a user interface of the server device 120. The user may submit requests to retrieve data from server device 120. The user may also submit requests to store data at server device 120. Server device 120 may receive the requests and respond by displaying the data on a user interface of the server device 120 or store data in a memory of the server device 120. In some embodiments, the requests and responses may be executed using HTTP. In some embodiments, the requests and responses may be data that may include web page data, such as an HTML web page.

While some of the above described embodiments contemplate using HTTP or HTML, one of ordinary skill in the art will appreciate that system 100 is not limited to the use of HTML or HTTP, and that some embodiments of the present invention can be used with any computer communication language or network protocol suitable for the purposes of the described communications between client device 110 and server device 120.

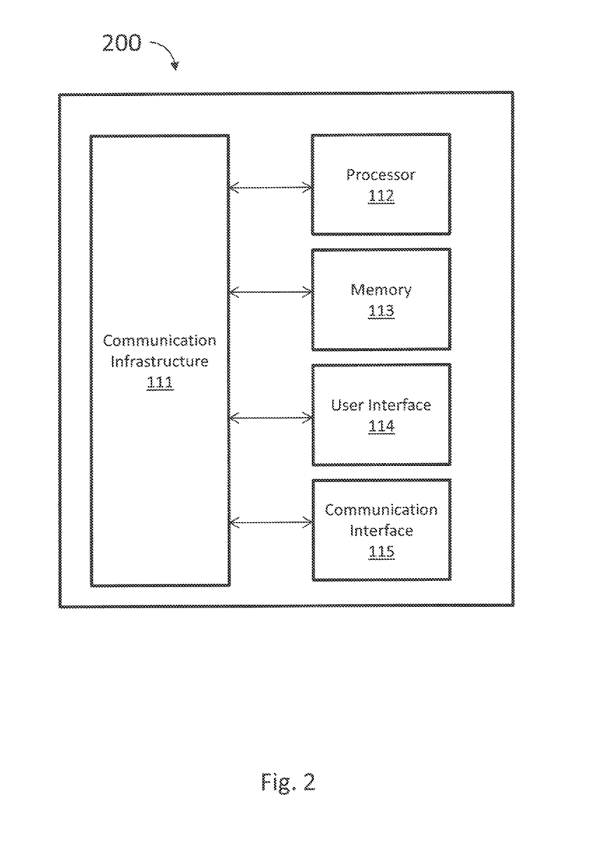

Any computing device or system described herein, including client device 110 and server device 120, may be implemented by a computer system such as computer system 200 as shown in FIG. 2. FIG. 2 is a block diagram showing the main components of a computer suitable for use in the system of FIG. 1 in accordance with at least one embodiment of the invention. Some embodiments of the present invention may be implemented as programmable code for execution by such computer system 200. However, it is contemplated that other embodiments of the present invention may be implemented using other computer systems and/or computer architectures.

Computer system 200 may include communication infrastructure 111, processor 112, memory 113, user interface 114 and/or communication interface 115.

Processor 112 may be any type of processor, including but not limited to a special purpose or a general-purpose digital signal processor. Processor 112 may be connected to a communication infrastructure (e.g. a data bus or computer network) either via a wired connection or a wireless connection. Various software implementations are described in terms of this exemplary computer system. After reading this description, it will become apparent to a person skilled in the art how to implement the invention using other computer systems and/or computer architectures.

Memory 113 may include at least one of: random access memory (RAM), a hard disk drive and a removable storage drive, such as a floppy disk drive, a magnetic tape drive, or an optical disk drive, etc. The removable storage drive reads from and/or writes to a removable storage unit. The removable storage unit can be a floppy disk, a magnetic tape, an optical disk, etc., which is read by and written to a removable storage drive. Memory 113 may include a computer usable storage medium having stored therein computer software programs and/or data to perform any of the computing functions of computer system 200. Computer software programs (also called computer control logic), when executed, enable computer system 200 to implement embodiments of the present invention as discussed herein. Accordingly, such computer software programs represent controllers of computer system 200.

Memory 113 may include one or more datastores, such as flat file databases, hierarchical databases or relational databases. The one or more datastores act as a data repository to store data such as flat files or structured relational records. While embodiments of the invention may include one or more of the memory or datastores listed above, it is contemplated that embodiments of the invention may incorporate different memory or data stores that are suitable for the purposes of the described data storage for computer system 200.

User interface 114 may be a program that controls a display (not shown) of computer system 200. User interface 114 may include one or more peripheral user interface components, such as a keyboard or a mouse. The user may use the peripheral user interface components to interact with computer system 200. User interface 114 may receive user inputs, such as mouse inputs or keyboard inputs from the mouse or keyboard user interface components.

User interface 114 may display data on the display of computer system 200 using a web browser. A web browser may be an application with the ability to render HTML pages, Cascading Style Sheets (CSS) and JavaScript content on the display of user interface 114. User interface 114 may display data, such as web pages, on the display of client device 110 using a mobile software application. One of ordinary skill in the art will appreciate that user interface 114 is not limited to displaying data using a web browser or a mobile software application, and that embodiments of the present invention may contemplate using other display devices or software suitable for the purposes of the displaying the data.

Communication interface 115 may allow data to be transferred between computer system 200 and an external device. Examples of communication interface 115 may include a modem, a network interface (such as an Ethernet card), a communication port, a Personal Computer Memory Card International Association (PCMCIA) slot and card, etc. Data transferred via communication interface 115 may be in the form of signals, which may be electronic, electromagnetic, optical, or other signals capable of being transmitted or received by communication interface. These signals are provided to or received from communication interface 115 and the external device via a network, such as network 130 shown in FIG. 1.

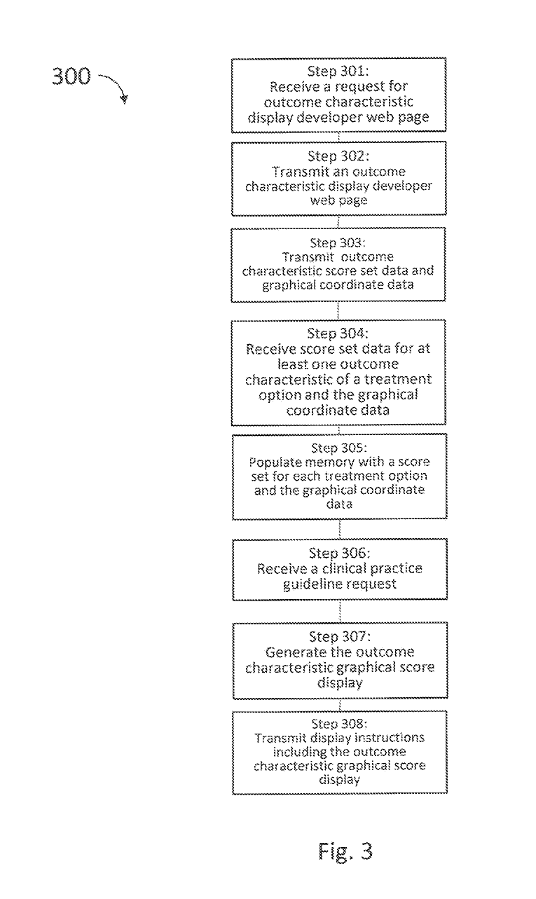

FIG. 3 shows a block diagram that illustrates a method 300 for improving medical decision-making by evaluating treatment options according to at least one embodiment of the invention.

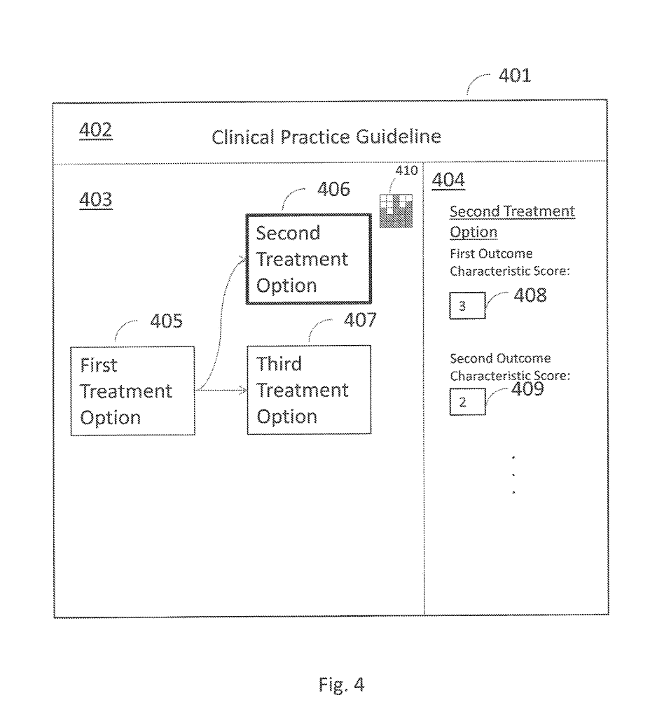

At step 301, processor 112 receives a request for an outcome characteristic display developer web page (an example of which is depicted in FIG. 4 and described in more detail below) from a guideline developer using client device 110 or user interface 114 of server device 120. In some embodiments, one or more outcome characteristic display developer web pages are employed. The outcome characteristic display developer web page is a functional tool that allows a guideline developer to associate outcome characteristic data, and/or a display of that data, with a treatment option for a clinical practice guideline. The outcome characteristic display developer web page may also be configured to develop a display that depicts, on user interface 114, the relationship between outcome characteristic data and treatment option(s) in a way that allows one or more users (e.g., clinicians, patients and the like) to quickly and efficiently associate (e.g., visually on a single display screen) an outcome characteristic score set with a treatment option.

The outcome characteristic display developer web page, when displayed on a user interface, such as user interface 114, may include a plurality of user-selectable icons (e.g., icons representing an outcome characteristic graphical score display or evidence block reflecting outcome characteristics, an example of which is described in more detail below) and/or a plurality of user-finable fields. Using the user-selectable icons and/or user-fillable fields, guideline developer(s) may associate outcome characteristic data with a treatment option for a clinical practice guideline. Some of the user-selectable icons in the outcome characteristic display developer web page may be movable such as via a peripheral user interface component (e.g. a computer mouse) associated with the user interface. In some embodiments, this functionality will enable a guideline developer to manipulate the position of a selected outcome characteristic graphical score display relative to a selected treatment option display. For example, a guideline developer may drag and drop a graphical score display into a position that would cause a user to associate that graphical score display with only a desired selected treatment option display. Thus, in one embodiment, the proximity of the graphical score display and the selected treatment option display is defined by graphical score display being displayed closer to the selected treatment option than another treatment option (e.g., a treatment option that may be associated with a different graphical score display).

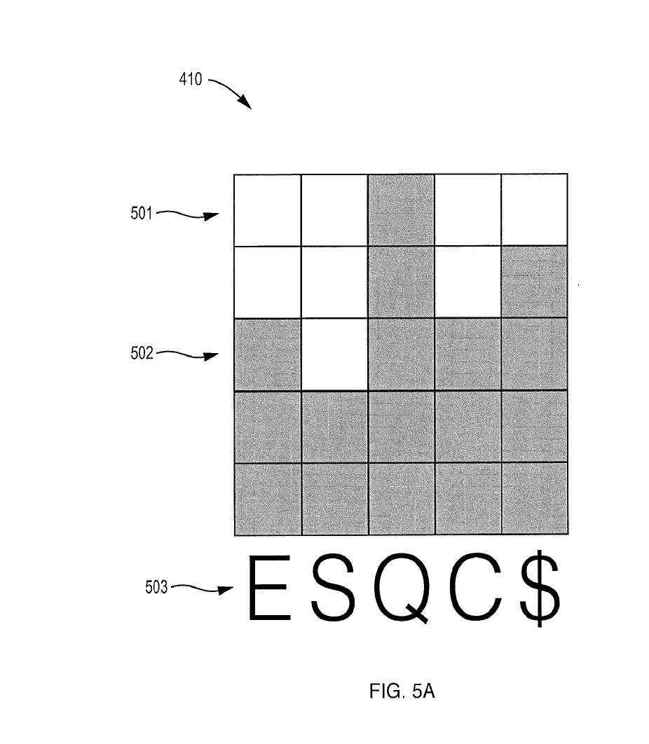

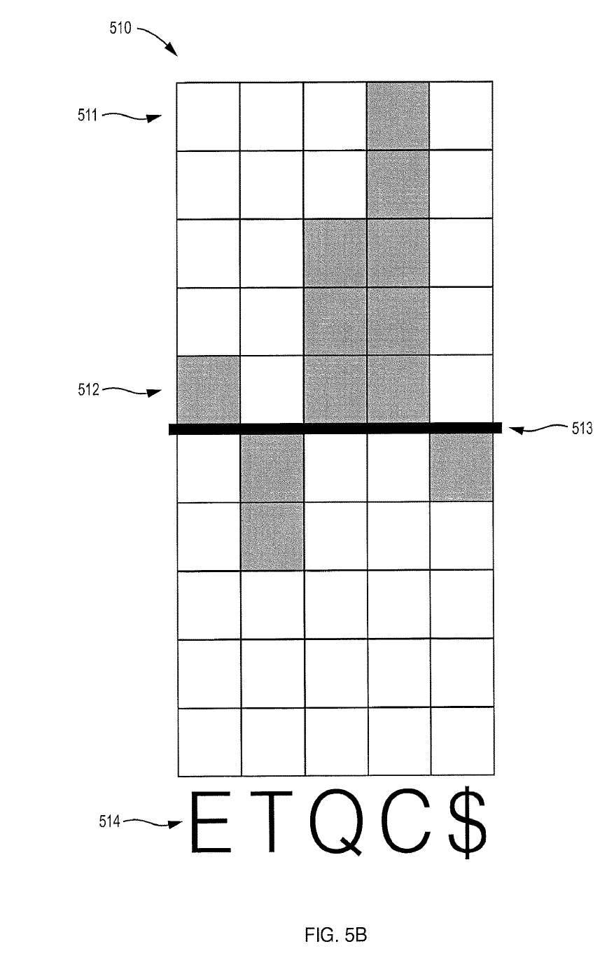

FIG. 4 depicts a screenshot of an exemplary outcome characteristic display developer web page according to at least one embodiment of the invention. The screenshot shows a display window 401 having a first sub-display window 402, a second sub-display window 403 and a third sub-display window 404. The first sub-display window 402 shows the name of the clinical practice guideline. The second sub-display window 403 shows one or more user-selectable icons (e.g. treatment option displays 405-407 and outcome characteristic graphical score display 410) associated with a clinical practice guideline. The treatment option display relates to a graphical representation of a treatment option for a clinical practice guideline. Outcome characteristic graphical score display 410 (e.g., an evidence block) may comprise a graphical representation of the at least one outcome characteristic score associated with a treatment option for a clinical practice guideline (See, e.g., FIG. 5A and the description below). In some embodiments, treatment option displays 405-407 and outcome characteristic graphical score display 410 are configured to be movable (e.g., by a guideline developer), in at least second sub-display window 403, using a peripheral user interface component. One example for moving an option is by “dragging and dropping” a treatment option display or outcome characteristic graphical score display at a user-specified location. To “drag and drop” an object, a user continuously selects an object using a peripheral user interface component. Then, once the object is moved, or “dragged,” to the user-specified location, the user deselects, or “drops” the object at that location. The graphical coordinates for any outcome characteristic graphical score display and any treatment option display are tracked and recorded by the user interface and transmitted to server device 120 for storage and later retrieval if a user makes a request for the graphical display of the clinical practice guideline.

A third sub-display window 404 shows user-fillable fields 408 and 409 that are presented, for example, when a treatment option display is selected. While only two user-fillable fields are shown, it is contemplated that more user-fillable fields may be provided. For example, each such field may correspond to a selected treatment option characteristic (e.g., efficacy, safety, data quality, consistency of evidence and affordability). In this example, the second treatment option is selected, as represented by a bold outline of treatment option display 406. User-fillable fields 408 and 409 allow a guideline developer to populate outcome characteristic scores for the selected treatment option to create an outcome characteristic score set (e.g., the set of scores assigned to each treatment option characteristic for a particular treatment option). In this example, a guideline developer has populated a score of three (3) in user-fillable field 408 for the first outcome characteristic score and a score of two (2) in user-fillable field 409 for the second outcome characteristic.

In one embodiment, outcome characteristic score set data includes one or more outcome characteristic scores. In some embodiments, the outcome characteristics scores may be developed by domain experts. Domain experts (e.g., one or more panel members) may, for example, assess one or more outcome characteristics associated with a treatment option (e.g., a treatment option reflected in clinical practice guideline) and assign, determine, calculate, and/or measure an outcome characteristic score based on that assessment. In some embodiments, an outcome characteristic score may be assigned to a single treatment option. In some embodiments, an outcome characteristic score may be assigned to a category of treatment options. For example, a safety score of 3 may be assigned to whole brain radiation and applied to a patient presenting with metastatic small cell lung cancer. In some embodiments, a safety score of 3 may be assigned to all applications of whole brain radiation.

FIG. 5A shows an example of an outcome characteristic graphical score display for a treatment option according to at least one embodiment of the invention. The outcome characteristic graphical score display 410 illustrated in FIG. 5A, is configured to simultaneously depict the score (e.g., a relative weight) associated with multiple factors that have been selected to provide end users with a graphical depiction of treatment options factors relating to a particular treatment option.

The factors selected for the outcome characteristic graphical score display of FIG. 5A (and described in more detail below) are: Efficacy (represented by column E), Safety (represented by column S), Quality of Evidence (represented by column Q), Consistency of Evidence (represented by column C) and Affordability (represented by column $). In some embodiments, Benefits (represented by a column B) may replace Efficacy. In some embodiments, Harms (represented by a column H) or Toxicity (represented by column T as shown in FIG. 5B) may replace Safety. In some embodiments, Cost (represented by column $ as shown in FIG. 5B) may replace Affordability.

One benefit to providing a graphical display incorporating a score associated with each of these factors is the ability of an end user to simultaneously view a relative weight among the factors. Such a graphical depiction is therefore useful for patients, with different needs and desires for a selected treatment option. For example, where one patient may prefer a highly effective treatment regime regardless of the safety that regime can be expected to impose on the patient, another patient may choose to give greater weight to safety factors and only choose options with highersafety even if a more efficacious option may be available. One patient may view affordability as an important factor and wish to choose an option based on a lower safety score and high affordability. The outcome characteristic graphical score display of FIG. 5A is configured to provide users with the ability to apply multiple patient specific criteria to a treatment option decision.

In some embodiments, the graphical representation of the outcome characteristic graphical score display and its corresponding positioning are configured, to allow a user (e.g., a clinician or patient) to simultaneously compare the full set of data (e.g., the outcome characteristic scores associated with each of the five outcome characteristics depicted in FIG. 5A) for a plurality of treatment options. In one embodiment, the graphical representation of treatment options in a hierarchical representation or taxonomy superimposed with outcome characteristic graphical score displays visually associated with one or more elements on the taxonomy, provides a use with multiple dimensions of information at a glance. One dimension may be, for example, the treatment option taxonomy itself. Another dimension, for example, is the number of outcome characteristics scored for each of the treatment options. A third dimension is the representation of multiple outcome characteristic scores in a single graphical score display for a treatment option. Such a configuration provides a rapid and useful graphical representation to assist the user of the guideline in evaluating a specific therapy or group of therapies. Then, by comparing all of the available treatment options for a clinical practice guideline, a clinician can decide the preferred course of treatment for a patient based upon the specific patient's priorities and the value-based score associated with available treatment options.

In the embodiment illustrated in FIG. 5A, the outcome characteristic graphical score display includes a plurality of indicia (e.g., cells). Cell 501 is an example of one of the plurality of cells. Each of the plurality of cells includes an indication—in FIG. 5A, that indicia is reflected in different shading applied to the cell. Cell 502 is an example of a shaded cell. The outcome characteristic score display may be configured to reflect the score set associated with a particular treatment option. For example, the indicia in the plurality of cells reflects a score set associated with a particular treatment option (e.g., the score set associated with subsequent chemotherapy for a patient presenting with a relapse of small cell lung cancer). The outcome characteristic graphical score display may further reflect each of the scores in a score set. For example, each of the indicia in the outcome characteristic graphical score display may also reflect each of the plurality of outcome characteristic scores included in the score set. For example, in FIG. 5A, the score set includes scores for five (5) outcome characteristics: a score of 3 for efficacy, a score of 2 for safety, a score of 5 for quality of evidence, a score of 3 for consistency of evidence and a score of 4 for affordability. The use of cells in the outcome characteristic graphical score display will aid a clinician in determining the information portrayed in the outcome characteristic graphical score display. In some embodiments, using clear delineations between different scores, the display will be easier to understand by a clinician as compared to shading techniques to show different gradation levels for an outcome characteristic. In some embodiments, the outcome characteristic graphical score display includes other comparative indicia representing a score to be given to a particular factor (e.g., Efficacy, Safety, Quality of Evidence, Consistency of Evidence, Affordability, Benefits, Harms). That indicia could include: a bar or column having a height reflective of the score or a notation such as a dot or other indicia as in a scatter graph. In each case the indicia may be displayed above, below, or to either side of a displayed axis. The indicia may not include discrete cells as are reflected in FIGS. 5A and 5B (described in more detail below). In some embodiments, symbols or letters may not be included proximate to the outcome characteristic graphical score display.

It is contemplated that, at least some aspects of the embodiments in FIGS. 5A and 5B are ornamental in nature. These ornamental aspects are depicted to show the decorative aspects of the outcome characteristic graphical score display.

The outcome characteristic graphical score display may be arranged in rows and columns in an array (see, e.g., FIGS. 5A and 5B). As illustrated in FIG. 5A, each column may represent one of the outcome characteristics for a treatment option. The scaled score for a specific outcome characteristic may be based on a ranking illustrated in the column (e.g. the number of shaded cells in a column) for a specific outcome characteristic. In one embodiment, the juxtaposition of a plurality of outcome characteristics enhances a user's evaluation criteria of a treatment option. For example, clinical guidelines that utilize the same ordering of outcome characteristics and the same scale of outcome characteristics may facilitate a faster comparison of the characteristic(s) in which a user may be interested. In some embodiments, the outcome characteristic graphical score display may include horizontal and vertical lines to define the array. In some embodiments, the outcome characteristic graphical score display may include only vertical lines to define the array. In some embodiments, the outcome characteristic graphical score display may only include horizontal lines to define the array.

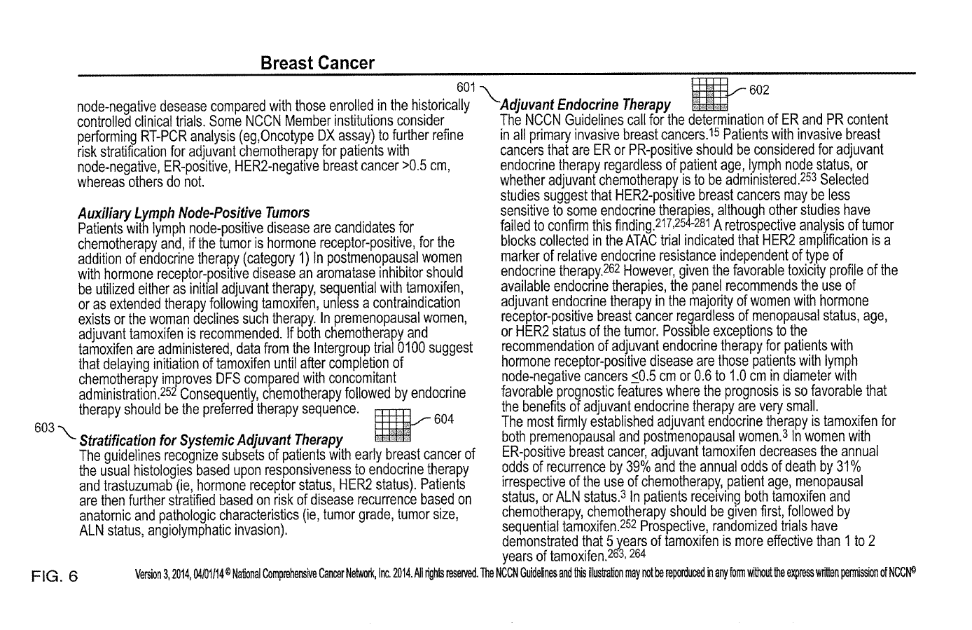

As shown in FIGS. 6-8, an outcome characteristic graphical score display is associated with a treatment option (e.g., a therapy) in connection with a clinical practice guideline. In the example illustrated in FIG. 5A, the outcome characteristic graphical score display is associated with an evaluation of the value of providing chemotherapy for hormone receptor negative metastatic breast cancer. The outcome characteristic graphical score display includes an array of cells arranged in rows and columns. Each column corresponds to an outcome characteristic. In the example in FIG. 5A, the outcome characteristics are efficacy (E), safety (S), quality of evidence (Q), consistency of evidence (C) and affordability ($), shown as element 503. For this specific therapy, the therapy may be moderately efficacious, moderately toxic, have high quality supporting evidence (e.g., many trials supporting its use), have some variability in trial results, and be very affordable. These characteristics may translate to numeric scores or values of three (3) for efficacy (E), two (2) for safety (S), five (5) for quality of evidence (Q), three (3) for consistency of evidence (C), and four (4) for affordability ($) respectively for this therapy.

To represent the scaled scores graphically, the number of shaded cells in a column for each outcome characteristic corresponds to the scaled scores. For example, in FIG. 5A, three cells are shaded for efficacy (E) to represent a numeric score of three (3), while two cells are shaded for safety (S) to represent a numeric score of two (2).

The outcome characteristic score may include a value level for an outcome characteristic. For example, in one embodiment, the outcome characteristic score may include five value levels. In one embodiment, the outcome characteristic score may range from a numerical value of 1 to 5. In embodiments where multiple outcome characteristic scores are used, each outcome characteristic score may be based on the same or different value scale or, outcome characteristic scores may be based on two or more value scales. Additionally, even where a first uniform scale is used for outcome characteristic scores at a particular location in a clinic practice guideline display—a second uniform scale (e.g., that is different from the first uniform scale) may be used at a different location in the guideline. Alternative embodiments of the invention contemplate using other types of score scaling for the purposes of describing an outcome characteristic.

One or more outcome characteristics may comprise evaluation criteria for selecting or considering a treatment option before determining whether to select the treatment option for a patient. Examples of outcome characteristics may include efficacy, benefits, safety, harms, quality of evidence, consistency of evidence, and/or affordability, among others.

Efficacy refers to the extent to which an intervention is helpful in prolonging life, arresting disease progression, or reducing symptoms of a medical condition. For non-therapeutic recommendations, such as, surgery or diagnostic tests, this scale may be modified to reflect the level of benefit for the intervention. Efficacy may be one of, if not the, most important outcome characteristic for any treatment option. Using available data from clinical trials, panel members may determine an appropriate efficacy level or score of a treatment option. Once efficacy levels for two or more treatment options are determined, clinicians can compare the treatment options based on efficacy to help determine a proper course of treatment for a patient.

For assessment of efficacy, the exemplary scale shown in Table 1 may be used by panel members:

TABLE 1

| EFFICACY | Characteristics | Score |
|---|---|---|
| Highly | Often provides long-term survival advantage | 5 |
| effective | or curative potential | |
| Very | Sometimes provides long-term survival | 4 |
| effective | advantage or curative potential | |
| Moderately | Little, no, or unknown impact on survival but | 3 |
| effective | often provides control of disease | |
| Minimally | Little, no, or unknown impact on survival and | 2 |
| effective | sometimes provides control of disease | |
| Palliative only | Symptomatic benefit only | 1 |

Sometimes, even when clinical trial data is available, a separate analysis may be required to analyze the efficacy determination in the clinical trials. For example, clinical trials in oncology characterize efficacy in a number of different ways, ranging from overall survival, to time to progression, to quality of life. These efficacy characterizations are reported as part of the publication of clinical trial results. Because of this heterogeneity, a scale that integrates these dimensions may be important to clinicians in evaluating information. Using the efficacy characterizations in the studies, the results may be interpreted to determine an efficacy score. For example, a score of 5 for efficacy may be assigned when treatments on trials demonstrating significant long-term survival benefit or cure are considered highly effective. In contrast, a score of 1 for efficacy may be assigned for treatment options that provide only palliation of symptoms.

For assessment of safety, the exemplary scale shown in Table 2 may be used:

TABLE 2

| SAFETY | Characteristics | Score |
|---|---|---|
| Usually | Uncommon or minimal side effects. No interference | 5 |
| no meaning- | with Activities of Daily Living (ADLs). | |
| ful toxicity | | |
| Occasionally | Rare significant toxicities or low grade toxicities | 4 |
| toxic | only. Little interference with ADLs. | |
| Mildly toxic | Experience of mild toxicity is common that | 3 |
| | interferes with ADLs. | |
| Moderately | Significant toxicities often occur; life threatening/ | 2 |
| toxic | fatal toxicity is uncommon. Interference with ADLs | |
| | is usual. | |
| Highly toxic | Usually severe, significant toxicities or live | 1 |
| | threatening/fatal toxicity often observed. | |
| | Interference with ADLs is usual and/or severe. | |

Note:
For significant chronic or long-term toxicities, decrease score by 1

Safety may refer to adverse experiences or harms related to a medical intervention. Safety may also refer to side effects of treatment by the lay public. Safety evaluation to determine a safety score may be based on clinical trials data. In oncology, treatments can be very toxic even life threatening because the risk of death from toxicity is less than the risk of death from disease. Clinical trials report both the type of toxicity by organ system and problem and the severity of toxicities reported ranging from no significant impact to fatal toxicities. Some common toxicities like neutropenia can result in life threatening infections, others like alopecia, while important to the patient have little impact on general health. Such considerations may be factors for making an overall assessment of the degree a resulting score. In some embodiments, for non-therapeutic interventions, such as diagnostic tests or surgery, this scale of the score may be modified to reflect the relative harms of the intervention.

While efficacy and safety scoring provides significant insight to a clinician when selecting a treatment option, providing a score for the quality of evidence in the clinical studies used to assess the reliability of a treatment option provides significant help to a clinician when deciding which treatment option to select. In some embodiments, two different evidence outcome characteristics may be used to determine a score for reliability of evidence.

The first outcome characteristic to measure reliability is the quality of the evidence. Quality of evidence may refer to the number and types of clinical trials relevant to a particular intervention. To determine a score for reliability the depth of the evidence (i.e. the numbers of trials that address this issue and their design) is considered. For example, randomized trials may be more reliable while non-randomized trials may be less reliable. Therefore, a treatment option that has more randomized trials than non-randomized trials may have a higher quality of evidence than a treatment option that has more non-randomized trials than randomized trials. Similarly, the more trials of any kind that address an issue, the more information about that issue is available.

For assessment of the quality of the evidence, the exemplary scale shown in Table 3 may be used:

TABLE 3

| QUALITY OF | | |
|---|---|---|
| EVIDENCE | Characteristics | Score |
| High quality | Multiple well designed randomized trials | 5 |
| | and/or meta-analysis | |
| Good quality | Several well designed randomized trials | 4 |
| Average quality | Low quality randomized trials or well | 3 |
| | designed non-randomized trials | |
| Low quality | Anecdotal evidence only | 2 |
| Poor quality or non- | Little or no evidence | 1 |
| meaningful evidence | | |

The second measure of reliability is consistency of the evidence for a treatment option. In one embodiment, consistency of evidence refers to the degree to which the clinical trials addressing an intervention have consistent results. In areas such as oncology, there are frequently several trials whose results are not consistent. For example, some trials may indicate one outcome, while other trials may indicate a different outcome. The inconsistency of the trials may result in a lower consistency of evidence score.

For assessment of the consistency of the evidence, the exemplary scale shown in Table 4 may be used:

TABLE 4

| CONSISTENCY | | |
|---|---|---|
| OF EVIDENCE | Characteristics | Score |
| Highly | Multiple trials with similar outcomes | 5 |
| consistent | | |
| Mainly | Multiple trials with some variability in outcome | 4 |
| consistent | | |
| May be | Few trials or only trials with few patients; | 3 |
| consistent | lower quality trials whether randomized or not | |
| Inconsistent | Meaningful differences in direction of outcome | 2 |
| | between quality trials | |
| Anecdotal | Evidence in humans based upon anecdotal | 1 |
| evidence only | experience | |

In one embodiment, affordability refers to the price of the intervention (e.g. the price paid by the payer). Affordability may also be a factor considered by a clinician when choosing a treatment option for a patient or by the patient in making choices about how to use a finite amount of personal financial resources. For assessment of the affordability, the exemplary scale shown in Table 5 may be used:

TABLE 5

| AFFORDABILITY | Characteristics | Score |
|---|---|---|
| Very inexpensive | Minimal cost | 5 |
| Inexpensive | Modest cost | 4 |
| Moderately | Costly | 3 |
| expensive | | |
| Expensive | Very costly | 2 |
| Very expensive | Extremely costly | 1 |

Note:
per episode for adjuvant therapy course
Note:
per month for treatment of metastatic disease

It would be appreciated by one of ordinary skill in the art that different design types of graphical displays may be implemented in different embodiments of the invention to depict a score associated with different outcome characteristics. For example, FIG. 5B shows an alternative example of an outcome characteristic graphical score display 510 for a treatment option according to at least one embodiment of the invention. In this alternative embodiment, scores for efficacy, quality of the evidence and consistency are shown by sequentially shaded cells above a baseline 513, while the scores for toxicity and cost are shown by sequentially shaded cells below the baseline 513. Similar to FIG. 5A, cell 511 is an example of one of a plurality of cells and cell 512 is an example of a shaded cell of a plurality of cells. The baseline may represent, for example, the best possible outcome for a specific outcome characteristic (e.g., cost, harm and/or toxicity). Therefore, the fewer the number of sequentially shaded cells shown for a specific outcome characteristic, the closer the specific outcome characteristic is to the best possible outcome. The baseline may also represent, for example, the least favorable possible outcome for a specific outcome characteristic (e.g., efficacy, quality of evidence, benefit, and consistency of evidence). In one embodiment, the outcome characteristic graphical score display includes a baseline that simultaneously represents the best possible outcome and least favorable outcome for selected outcome characteristics (e.g., FIG. 5B).

In the example in FIG. 5B, similar to FIG. 5A, the outcome characteristics 514 are efficacy (E), toxicity (T), quality of evidence (Q), consistency of evidence (C) and cost ($). The assessment of efficacy, quality of the evidence and consistency of the evidence use Tables 1, 3 and 4 respectively, as described above. However, the assessments for safety and affordability are replaced with toxicity and cost, respectively, in FIG. 5B.

For assessment of toxicity, in FIG. 5B, the exemplary scale shown in Table 6 may be used:

TABLE 6

| TOXICITY | Characteristics | Score |
|---|---|---|
| Usually no | Uncommon or minimal side | 1 |
| meaningful | effects. No interference with | |
| toxicity | Activities of Daily Living (ADLs). | |
| Occasionally | Rare significant toxicities or | 2 |
| toxic | low grade toxicities only. | |
| | Little interference with ADLs. | |
| Mildly toxic | Experience of mild toxicity is | 3 |
| | common that interferes with ADLs. | |
| Moderately | Significant toxicities often occur; life | 4 |
| toxic | threatening/fatal toxicity is uncommon. | |
| | Interference with ADLs is usual. | |
| Highly toxic | Usually severe, significant toxicities or live | 5 |
| | threatening/fatal toxicity often observed. | |
| | Interference with ADLs is usual and/or severe. | |

Note:
For significant chronic or long-term toxicities, increase score by 1

For assessment of the cost, in FIG. 5B, the exemplary scale shown in Table 7 may be used:

TABLE 7

| COST | Characteristics | Score |
|---|---|---|
| Minimal cost | Minimal cost | 1 |
| Modest cost | Modest cost | 2 |
| Costly | Costly | 3 |
| Very costly | Very costly | 4 |
| Extremely costly | Extremely costly | 5 |

Note:
per episode for adjuvant therapy course
Note:
per month for treatment of metastatic disease

Using the above tables referenced for FIG. 5B, for the specific therapy shown, the therapy may be palliative only, occasionally toxic, have average quality supporting evidence (e.g., low quality randomized trials or well designed non-randomized trials), have highly consistent trial results, and be minimal in cost. These characteristics may translate to numeric scores or values of one (1) for efficacy (E), two (2) for toxicity (T), three (3) for quality of evidence (Q), five (5) for consistency of evidence (C), and one (1) for cost ($) respectively, for this therapy.

Referring back to FIG. 3, in one embodiment, at step 302, in response to receiving the request for an outcome characteristic display developer web page, processor 112 transmits the outcome characteristic display developer web page to, for example, the guideline developer. The guideline developer may then populate and submit the outcome characteristic score set data for a treatment option along with the graphical coordinate data for the treatment option display and the outcome characteristic graphical score display.

At step 303, the outcome characteristic score set data and graphical coordinate data for the treatment option display and the outcome characteristic graphical score display are transmitted from the guideline developer to processor 112 for further processing.

At step 304, processor 112 receives outcome characteristic score set data for a plurality of outcome characteristics of a treatment option and graphical coordinate data for the treatment option display and the outcome characteristic graphical score display.

There are a number of different methods for receiving outcome characteristic score set data contemplated by different embodiments of the invention. For example, the outcome characteristic score set may be received from client device 110 via network 130. Alternatively, the outcome characteristic score set data may be received via a user interface 114 of server device 120. The outcome characteristic score set data may include at least one outcome characteristic and a corresponding score for a treatment option and/or a clinical practice guideline.

At step 305, processor 112 populates memory 113 with an outcome characteristic score set for each treatment option and the graphical coordinate data for the treatment option display and the outcome characteristic graphical score display. In one embodiment, memory 113 may be a database that stores each outcome characteristic score in the score set for a treatment option and/or each graphical coordinate data for the treatment option display and/or the outcome characteristic graphical score display as a record (or related records) in the database. The fields for each record in the database may include at least one of: the outcome characteristic, the treatment option, the clinical practice guideline, the outcome characteristic score and graphical coordinate data. However, it is contemplated by other embodiments of the invention that other combinations of fields, as well as combinations of database tables, may be used for the purposes of storing outcome characteristic scores and score sets in a relational manner in memory 113.

At step 306, processor 112 receives a clinical practice guideline display request. Once the request is processed and the clinical practice guideline display is transmitted to processor 112, the clinical practice guideline display is displayed on a user interface 114. The clinical practice guideline display may include information about treatment options associated with a specific clinical practice guideline. If the clinical practice guideline display includes an outcome characteristic graphical score display and a treatment option display, as originally created by a guideline developer using the outcome characteristic display developer web page, then the graphical display of the clinical practice guidelines will include the outcome characteristic graphical score display and the treatment option display.

At step 307, processor 112 generates the outcome characteristic graphical score display.

According to one embodiment of the invention, processor 112 retrieves, from memory 113, the outcome characteristic graphical score display template. Next, processor 112 retrieves, from memory 113, each outcome characteristic score for a corresponding outcome characteristic associated with a treatment option and/or clinical practice guideline. Based on the outcome characteristic score for each corresponding outcome characteristic, processor 112 populates a corresponding number of shaded cells in the outcome characteristic graphical score display template for the column associated with the outcome characteristic to create an outcome characteristic graphical score display for the treatment option. Then, processor 112 incorporates the outcome characteristic graphical score display into display instructions that are sent in response to the clinical practice guideline display request.

In one embodiment, processor 112 may also associate one or more hyperlinks with the outcome characteristic graphical score display. In one embodiment, each graphical score display includes a hyperlink that, when selected, causes processor 112 to transmit a web page that displays reference data used to determine one or more outcome characteristic score. In another embodiment, wherein each graphical score display includes a plurality of hyperlinks, each hyperlink corresponds to a specific outcome characteristic score reflected on the graphical score display and is configured to cause processor 112 to transmit a web page that displays reference data used to determine the specific outcome characteristic score. For example, when a user selects a hyperlink associated with a affordability score of a graphical score display, processor 112 may transmit historical affordability data for the treatment option described in a peer-reviewed journal.

At step 308, processor 112 transmits display instructions that, when implemented by user interface 114, result in a clinical practice guideline graphical display of at least one outcome characteristic graphical score display associated with at least one treatment option display on user interface 114.

The instructions, when executed by a user interface such as user interface 114, causes an outcome characteristic graphical score display to display proximate a treatment option display on a user interface 114 such that a user associates the outcome characteristic graphical score display with the treatment option display. For example, the instructions may provide graphical coordinates for the outcome characteristic graphical score display and the treatment option display. When the instructions are executed by the user interface, the user interface may recognize the graphical coordinates for the outcome characteristic graphical score display and the treatment option display and generate a graphical display that positions the outcome characteristic graphical score display proximate the treatment option display.

Different embodiments of the invention contemplate different configurations for arranging an outcome characteristic graphical score display proximate to a treatment option display. FIGS. 6-8 show exemplary embodiments for arranging the outcome characteristic graphical score display proximate to a treatment option display in different display formats according to some embodiments of the invention.

FIG. 6 is a screenshot of a first configuration of the outcome characteristic graphical score display proximate a treatment option display according to at least one embodiment of the invention. In this example, the treatment option displays 601 and 603 are arranged in paragraph format. As shown, outcome characteristic graphical score displays 602 and 604 are displayed proximate treatment option displays 601 and 603 respectively.

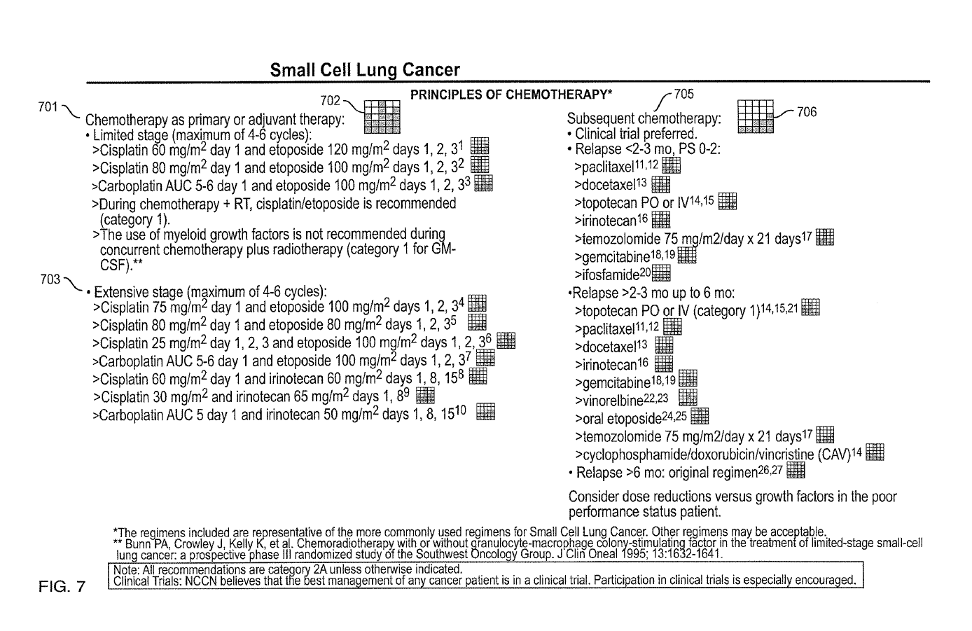

FIG. 7 is a screenshot of a second configuration of the outcome characteristic graphical score display proximate a treatment option display according to at least one embodiment of the invention. In this example, the treatment option displays 701, 703 and 705 are arranged in list format. As shown, outcome characteristic graphical score displays 702, 704 and 706 are displayed proximate treatment option displays 701, 703 and 705 respectively.

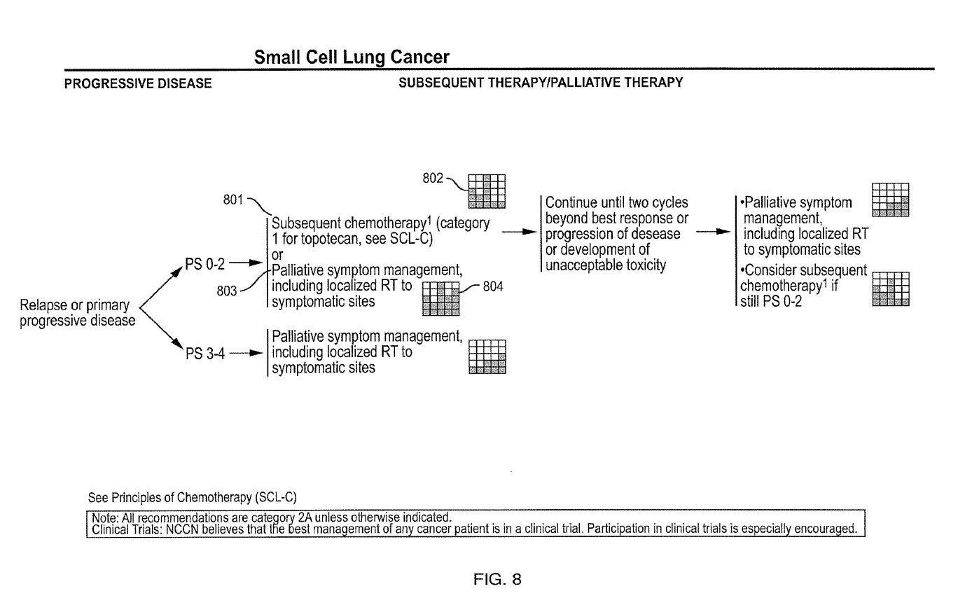

FIG. 8 is a screenshot of a third configuration of the outcome characteristic graphical score display proximate a treatment option display according to at least one embodiment of the invention. In this example, the treatment option displays 801 and 803 are arranged in flow chart format. As shown, outcome characteristic graphical score displays 802 and 804 are displayed proximate treatment option displays 801 and 803 respectively.

Multiple outcome characteristic graphical score displays may be displayed simultaneously on user interface 114. For example, FIG. 6 shows exemplary outcome characteristic graphical score displays 602 and 604, among others, in the same screenshot display; FIG. 7 shows exemplary outcome characteristic graphical score displays 702, 704 and 706, among others, in the same screenshot display; and FIG. 8 shows exemplary outcome characteristic graphical score displays 802 and 804, among others, in the same screenshot display. The multiple outcome characteristic graphical score displays allow a user to compare the at least two outcome characteristic graphical score displays without toggling between different user interface displays.

In at least one embodiment, the system 100 includes one or more computers having one or more processors and memory (e.g., one or more nonvolatile storage devices). In some embodiments, memory or computer readable storage medium of memory stores programs, modules and data structures, or a subset thereof for a processor to control and run the various systems and methods disclosed herein. In one embodiment, a non-transitory computer readable storage medium having stored thereon computer-executable instructions which, when executed by a processor, perform one or more of the methods disclosed herein.

The non-transitory computer readable storage media may include volatile and non-volatile, removable and non-removable media implemented in any method or technology for storage of information such as computer-readable instructions, data structures, program modules, or other data. Computer readable storage media may include, but is not limited to, RAM, ROM, Erasable Programmable ROM (EPROM), Electrically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be configured to store the desired information and which can be accessed by the computer system.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the method does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

I/We claim:

1. A computer-implemented method of ranking and presenting evaluation criteria for medical treatment options, comprising:
populating, by a computer processor, a database with a score set for each of a plurality of treatment options, the score set including a plurality of outcome characteristic scores;
transmitting, by the computer processor, first display instructions that when implemented results in a plurality of graphical score displays and a plurality of treatment option displays,
wherein each graphical score display having a plurality of indicia having an indication that reflects: i) one of the score sets and ii) the plurality of outcome characteristic scores included in the score set, the instructions further causing each graphical score display to display proximate one of the treatment option displays such that a user associates the graphical score display with the treatment option display.

2. The method of claim 1, wherein each of the plurality of outcome characteristic scores represents an outcome characteristic of at least one of: efficacy, benefit, toxicity, safety, quality of evidence, consistency of evidence, cost and affordability.

3. The method of claim 1, wherein each graphical score display comprises an array including a plurality of cells and wherein the plurality of cells are arranged in rows and columns in the array, each column representing one of the outcome characteristics.

4. The method of claim 1, wherein each of the outcome characteristic scores is determined based on the same numerical scale that includes five value levels.

5. The method of claim 1, wherein one of the plurality of outcome characteristics includes efficacy and wherein the outcome characteristic score for efficacy is ranked according to the group consisting of highly effective, very effective, moderately effective, minimally effective and palliative only.

6. The method of claim 1, wherein at least two graphical score displays are displayed simultaneously such a user can compare the at least two graphical score displays.

7. The method of claim 1, wherein the database includes at least one of: an outcome characteristic field, a treatment option field, a clinical practice guideline field and an outcome characteristic score field.

8. The method of claim 1, wherein one of the plurality of outcome characteristics includes safety and wherein the outcome characteristic score for safety is ranked according to the group consisting of usually no meaningful toxicity, occasionally toxic, mildly toxic, moderately toxic, highly toxic.

9. The method of claim 1, wherein one of the plurality of outcome characteristics includes quality of evidence and wherein the outcome characteristic score for quality of evidence is ranked according to the group consisting of high quality, good quality, average quality, low quality, poor quality or non-meaningful evidence.

10. The method of claim 1, wherein one of the plurality of outcome characteristics includes consistency of evidence and wherein the outcome characteristic score for consistency of evidence is ranked according to the group consisting of highly consistent, mainly consistent, may be consistent, inconsistent, anecdotal evidence only.

11. The method of claim 1, wherein one of the plurality of outcome characteristics includes affordability and wherein the outcome characteristic score for affordability is ranked according to the group consisting of very inexpensive, inexpensive, moderately expensive, expensive, very expensive.

12. The method of claim 1, wherein each of the outcome characteristic scores is determined based on the same numerical scale.

13. The method of claim 1, further comprising:
receiving, by the computer processor, a request for an outcome characteristic display developer web page.

14. The method of claim 1, further comprising:
transmitting, by the computer processor, the outcome characteristic display developer web page to a client device;

15. The method of claim 1, further comprising:
receiving, by the computer processor, the score set associated with each of the plurality of treatment options.

16. The method of claim 14, further comprising:
receiving, by the computer processor, first graphical coordinate data associated with each of the plurality of treatment option displays, in response to user input via user-selectable and user-movable treatment option displays on the outcome characteristic display developer web page.

17. The method of claim 16, further comprising:
populating, by the computer processor, the database with the first graphical coordinate data associated with each of the plurality of treatment option displays.

18. The method of claim 14, further comprising:
receiving, by the computer processor, second graphical coordinate data associated with each of the plurality of graphical score displays, in response to user input via user-selectable and user-movable graphical elements representing the graphical score displays on the outcome characteristic display developer web page.

19. The method of claim 18, further comprising:
populating, by the computer processor, the database with the second graphical coordinate data associated with each of the plurality of graphical score displays.

20. The method of claim 1, wherein the first graphical coordinate data and the second graphical coordinate data are applied to produce the instructions further causing each graphical score display to display proximate one of the treatment option displays such that an end user associates the graphical score display with the treatment option display.

21. The method of claim 1, wherein at least two graphical score displays simultaneous display on a single screen so that an end user view the screen can simultaneously view the at least two graphical score displays.

22. The method of claim 1, wherein each graphical score display includes a hyperlink that, when selected, causes the computer processor to transmit a web page that displays reference data used to determine one or more outcome characteristic scores.

23. The method of claim 1, wherein each graphical score display includes a plurality of hyperlinks, each hyperlink corresponding to a specific outcome characteristic score reflected on the graphical score display and being configured to cause the computer processor to transmit a web page that displays reference data used to determine the specific outcome characteristic score.

24. A system of ranking and presenting evaluation criteria for medical treatment options, comprising:
one or more memory units each operable to store at least one program; and
at least one processor communicatively coupled to the one or more memory units, in which the at least one program, when executed by the at least one processor, causes the at least one processor to perform the steps of:
populating, by a computer processor, a database with a score set for each of a plurality of treatment options, the score set including a plurality of outcome characteristic scores;
transmitting, by the computer processor, first display instructions that when implemented results in a plurality of graphical score displays and a plurality of treatment option displays,
wherein each graphical score display having a plurality of indicia having an indication that reflects: i) one of the score sets and ii) the plurality of outcome characteristic scores included in the score set, the instructions further causing each graphical score display to display proximate one of the treatment option displays such that a user associates the graphical score display with the treatment option display.

25. The system of claim 24 wherein each of the plurality of outcome characteristic scores represents an outcome characteristic of at least one of: efficacy, benefit, toxicity, safety, harm, quality of evidence, consistency of evidence, cost and affordability.

26. The system of claim 24, wherein each graphical score display comprises an array including a plurality of cells and wherein the plurality of cells are arranged in rows and columns in the array, each column representing one of the outcome characteristics.

27. The system of claim 24, wherein each of the outcome characteristic scores is determined based on the same numerical scale that includes five value levels.

28. The system of claim 24, wherein one of the plurality of outcome characteristics includes efficacy and wherein the outcome characteristic score for efficacy is ranked according to the group consisting of highly effective, very effective, moderately effective, minimally effective and palliative only.

29. The system of claim 24, wherein at least two graphical score displays are displayed simultaneously such a user can compare the at least two graphical score displays.

30. The system of claim 24, wherein the database includes at least one of: an outcome characteristic field, a treatment option field, a clinical practice guideline field and an outcome characteristic score field.

31. The system of claim 24, wherein one of the plurality of outcome characteristics includes safety and wherein the outcome characteristic score for safety is ranked according to the group consisting of usually no meaningful toxicity, occasionally toxic, mildly toxic, moderately toxic, highly toxic.

32. The system of claim 24, wherein one of the plurality of outcome characteristics includes quality of evidence and wherein the outcome characteristic score for quality of evidence is ranked according to the group consisting of high quality, good quality, average quality, low quality, poor quality or non-meaningful evidence.

33. The system of claim 24, wherein one of the plurality of outcome characteristics includes consistency of evidence and wherein the outcome characteristic score for consistency of evidence is ranked according to the group consisting of highly consistent, mainly consistent, may be consistent, inconsistent, anecdotal evidence only.

34. The system of claim 24, wherein one of the plurality of outcome characteristics includes affordability and wherein the outcome characteristic score for affordability is ranked according to the group consisting of very inexpensive, inexpensive, moderately expensive, expensive, very expensive.

35. The system of claim 24, wherein each of the outcome characteristic scores is determined based on the same numerical scale.

36. The system of claim 24, wherein the processor further performs the step(s) of:
receiving, by the computer processor, a request for an outcome characteristic display developer web page.

37. The system of claim 24, wherein the processor further performs the step(s) of:
transmitting, by the computer processor, the outcome characteristic display developer web page to a client device;

38. The system of claim 24, wherein the processor further performs the step(s) of:
receiving, by the computer processor, the score set associated with each of the plurality of treatment options.

39. The system of claim 37, wherein the processor further performs the step(s) of:
receiving, by the computer processor, first graphical coordinate data associated with each of the plurality of treatment option displays, in response to user input via user-selectable and user-movable treatment option displays on the outcome characteristic display developer web page.

40. The system of claim 39, wherein the processor further performs the step(s) of:
populating, by the computer processor, the database with the first graphical coordinate data associated with each of the plurality of treatment option displays.

41. The system of claim 37, wherein the processor further performs the step(s) of:
receiving, by the computer processor, second graphical coordinate data associated with each of the plurality of graphical score displays, in response to user input via user-selectable and user-movable graphical elements representing the graphical score displays on the outcome characteristic display developer web page.

42. The system of claim 41, wherein the processor further performs the step(s) of:
populating, by the computer processor, the database with the second graphical coordinate data associated with each of the plurality of graphical score displays.

43. The system of claim 24, wherein the first graphical coordinate data and the second graphical coordinate data are applied to produce the instructions further causing each graphical score display to display proximate one of the treatment option displays such that an end user associates the graphical score display with the treatment option display.

44. The system of claim 24, wherein at least two graphical score displays simultaneous display on a single screen so that an end user view the screen can simultaneously view the at least two graphical score displays.

45. The system of claim 24, wherein each graphical score display includes a hyperlink that, when selected, causes the computer processor to transmit a web page that displays reference data used to determine one or more outcome characteristic scores.

46. The system of claim 24, wherein each graphical score display includes a plurality of hyperlinks, each hyperlink corresponding to a specific outcome characteristic score reflected on the graphical score display and being configured to cause the computer processor to transmit a web page that displays reference data used to determine the specific outcome characteristic score.

47. A non-transitory computer readable storage medium having stored thereon computer-executable instructions which, when executed by a processor, performs the steps of:
populating, by a computer processor, a database with a score set for each of a plurality of treatment options, the score set including a plurality of outcome characteristic scores;
transmitting, by the computer processor, first display instructions that when implemented results in a plurality of graphical score displays and a plurality of treatment option displays,
wherein each graphical score display having a plurality of indicia having an indication that reflects: i) one of the score sets and ii) the plurality of outcome characteristic scores included in the score set, the instructions further causing each graphical score display to display proximate one of the treatment option displays such that a user associates the graphical score display with the treatment option display.

48. The non-transitory computer readable storage medium of claim 47, wherein each of the plurality of outcome characteristic scores represents an outcome characteristic of at least one of: efficacy, benefit, toxicity, safety, harm, quality of evidence, consistency of evidence, cost and affordability.

49. The non-transitory computer readable storage medium of claim 47, wherein each graphical score display comprises an array including a plurality of cells and wherein the plurality of cells are arranged in rows and columns in the array, each column representing one of the outcome characteristics.

50. The non-transitory computer readable storage medium of claim 47, wherein each of the outcome characteristic scores is determined based on the same numerical scale that includes five value levels.

51. The non-transitory computer readable storage medium of claim 47, wherein one of the plurality of outcome characteristics includes efficacy and wherein the outcome characteristic score for efficacy is ranked according to the group consisting of highly effective, very effective, moderately effective, minimally effective and palliative only.

52. The non-transitory computer readable storage medium of claim 47, wherein at least two graphical score displays are displayed simultaneously such a user can compare the at least two graphical score displays.

53. The non-transitory computer readable storage medium of claim 47, wherein the database includes at least one of: an outcome characteristic field, a treatment option field, a clinical practice guideline field and an outcome characteristic score field.

54. The non-transitory computer readable storage medium of claim 47, wherein one of the plurality of outcome characteristics includes safety and wherein the outcome characteristic score for safety is ranked according to the group consisting of usually no meaningful toxicity, occasionally toxic, mildly toxic, moderately toxic, highly toxic.

55. The non-transitory computer readable storage medium of claim 47, wherein one of the plurality of outcome characteristics includes quality of evidence and wherein the outcome characteristic score for quality of evidence is ranked according to the group consisting of high quality, good quality, average quality, low quality, poor quality or non-meaningful evidence.

56. The non-transitory computer readable storage medium of claim 47, wherein one of the plurality of outcome characteristics includes consistency of evidence and wherein the outcome characteristic score for consistency of evidence is ranked according to the group consisting of highly consistent, mainly consistent, may be consistent, inconsistent, anecdotal evidence only.

57. The non-transitory computer readable storage medium of claim 47, wherein one of the plurality of outcome characteristics includes affordability and wherein the outcome characteristic score for affordability is ranked according to the group consisting of very inexpensive, inexpensive, moderately expensive, expensive, very expensive.

58. The non-transitory computer readable storage medium of claim 47, wherein each of the outcome characteristic scores is determined based on the same numerical scale.

59. The non-transitory computer readable storage medium of claim 47, wherein the processor further performs the step(s) of:
receiving, by the computer processor, a request for an outcome characteristic display developer web page.

60. The non-transitory computer readable storage medium of claim 47, wherein the processor further performs the step(s) of:
transmitting, by the computer processor, the outcome characteristic display developer web page to a client device;

61. The non-transitory computer readable storage medium of claim 47, wherein the processor further performs the step(s) of:
receiving, by the computer processor, the score set associated with each of the plurality of treatment options.

62. The non-transitory computer readable storage medium of claim 60, wherein the processor further performs the step(s) of:
receiving, by the computer processor, first graphical coordinate data associated with each of the plurality of treatment option displays, in response to user input via user-selectable and user-movable treatment option displays on the outcome characteristic display developer web page.

63. The non-transitory computer readable storage medium of claim 62, wherein the processor further performs the step(s) of:
populating, by the computer processor, the database with the first graphical coordinate data associated with each of the plurality of treatment option displays.

64. The non-transitory computer readable storage medium of claim 60, wherein the processor further performs the step(s) of:
receiving, by the computer processor, second graphical coordinate data associated with each of the plurality of graphical score displays, in response to user input via user-selectable and user-movable graphical elements representing the graphical score displays on the outcome characteristic display developer web page.

65. The non-transitory computer readable storage medium of claim 64, wherein the processor further performs the step(s) of:
populating, by the computer processor, the database with the second graphical coordinate data associated with each of the plurality of graphical score displays.

66. The non-transitory computer readable storage medium of claim 47, wherein the first graphical coordinate data and the second graphical coordinate data are applied to produce the instructions further causing each graphical score display to display proximate one of the treatment option displays such that an end user associates the graphical score display with the treatment option display.

67. The non-transitory computer readable storage medium of claim 47, wherein at least two graphical score displays simultaneous display on a single screen so that an end user view the screen can simultaneously view the at least two graphical score displays.

68. The non-transitory computer readable storage medium of claim 47, wherein each graphical score display includes a hyperlink that, when selected, causes the computer processor to transmit a web page that displays reference data used to determine one or more outcome characteristic scores.

69. The non-transitory computer readable storage medium of claim 47, wherein each graphical score display includes a plurality of hyperlinks, each hyperlink corresponding to a specific outcome characteristic score reflected on the graphical score display and being configured to cause the computer processor to transmit a web page that displays reference data used to determine the specific outcome characteristic score.
